(19) United States
(12) Patent Application Publication
(10) Pub. No.: US 2005/0229040 A1
(43) Pub. Date: Oct. 13, 2005

(54) Communication system with users and diagnostic units

(75) Inventors: Michael Franke, Erlangen-Dechsendorf (DE); Karl-Heinz Krause, Nuernberg (DE); Michael Koestner, Karlsruhe (DE)

Correspondence Address: SUGHRUE MION, PLLC, 2100 Pennsylvania Avenue, NW, Washington, DC, 20037-3213, US

(73) Assignee: SIEMENS AKTIENGESELLSCHAFT

(21) Appl. No.: 11/087,647

(22) Filed: Mar. 24, 2005

Related U.S. Application Data
(63) Continuation of application No. PCT/DE03/03015, filed on Sep. 11, 2003.

(30) Foreign Application Priority Data
Sep. 24, 2002 (DE) 102 444 27.7

(51) Int. Cl. G06F 11/00

(52) U.S. Cl. 714/25

(57) ABSTRACT

A distributed automation communication system, in particular a real-time critical, cyclic, real-time Ethernet system, which has a plurality of users. Each user has at least one diagnostic unit (7, 8, 15) for the diagnosis and recording of data concerning the data exchange between users. In addition, the communication system (1) has a further user embodied as a central diagnostic terminal (13). The central diagnostic terminal (13) carries out a central diagnosis of the whole communication system (1) by configuration of the diagnostic units (7, 8, 15) of the users and calling up and analyzing the diagnostic data recorded by the diagnostic units (7, 8, 15) of the users.

This is a Continuation of International Application PCT/DE2003/003015, with an international filing date of Sep. 11, 2003, which was published under PCT Article 21(2) in German, and the disclosure of which is incorporated into this application by reference.

### FIELD AND BACKGROUND OF THE INVENTION

1. Field of the Invention

The present invention relates to a communication system having users provided with a diagnostic unit.

2. Description of Related Art

A communication system is defined as a system with at least two users that are interconnected over a data network for the mutual exchange of data or the mutual transmission of data.

Users are, for example, central automation devices, programming, configuration or operating units, peripheral devices, such as input/output modules, drives, actuators, sensors, stored program controllers (SPCs) or other control units, computers or machines that exchange electronic data with other users and, in particular, computers or machines that process data of other users. Users are also referred to as network nodes or nodes.

Control units, as used hereinafter, are defined as open-loop or closed-loop control units of all types as well as, for example, coupling units (so-called switches) and/or switch controllers. The data networks used are, for example, switched communication systems, such as switched Ethernet, industrial Ethernet and, in particular, isochronous real-time Ethernet.

In today's switched communication systems, the communication relations among the users are controlled by the network components through dedicated network segments. Controlling the relations among the users by using the network components through the dedicated network segments relieves segments that are not involved in the communication. As a result, there is no longer a central unit handling all of the communication, such as a repeater in a communication bus. Accordingly, the possibility of performing a central diagnosis of a communication system is also lost.

In the related art techniques, the diagnosis of the above described communication systems was performed by connected, decentralized analyzers. That is, the analyzer is connected to the respective network component, where it records the data traffic. The analysis is performed by manually evaluating the recording log. For a complete recording, since not all communication relations necessarily pass through a single node with respect to their path within the communication system, the analyzer may, under certain circumstances, have to be simultaneously connected to several points of the communication system.

### OBJECTS OF THE INVENTION

One object of the present invention is to provide an improved communication system that enables a central diagnosis of the communication system of the above described type.

Illustrative, non-limiting embodiments of the present invention may overcome the above disadvantages and other disadvantages not described above. The present invention is not necessarily required to overcome any of the disadvantages described above, and the illustrative, non-limiting embodiments of the present invention may not overcome any of the problems described above. The appended claims should be consulted to ascertain the true scope of the invention.

### SUMMARY OF THE INVENTION

According to an exemplary, non-limiting formulation of the present invention, a communication system having at least one first and one second user is provided. These users are interconnected by at least one communication connection. In addition, the users have at least one diagnostic unit, which is provided for the diagnosis of data concerning the data exchange in at least one communication relation between at least two users.

Preferably, the diagnostic unit has at least one evaluation unit. This evaluation unit evaluates the diagnostic data. According to another variation of an illustrative formulation of the present invention, the diagnostic unit has at least one buffer memory buffering the diagnostic data. The data thus evaluated and buffered can be readily transferred into a memory of the respective user, since the diagnostic unit is integrated into the respective user, and thus connected directly to the remaining components of the user, such as a computer, for example, and in particular is also connected, and has access to, a memory of the user. The data stored therein can then be retrieved and evaluated at any time, for example, by another user of the communication system.

According to yet another variation of the illustrative formulation of the present invention, the communication system is an Ethernet type or real-time Ethernet type switched communication system. It is particularly preferable if the communication system is a cyclically operating communication system, in which the communication among the users takes place in transmission cycles. In a switched communication system of this type, at least one coupling unit is switched between two users and is connected to both users.

Each coupling unit may, however, also be connected to more than two users. Each user is connected to at least one coupling unit but not directly to another user. A coupling unit is also referred to as a switch. Such a high-performance data network may have a large number of distributed users, particularly, also a large number of distributed switches. These switches can be separate network users but can also be integrated into a user. For real-time applications, the time of arrival and transmission of the messages in the switches or the other users is important for the transit of the messages through the communication system. The monitoring of messages and the tracking of messages over time within the communication system, for example, to reconstruct the occurrence of fault events, is also important. Such recording mechanisms are, for example, statistics on the message load or communication load within a time unit or at specific instants, the number of received or transmitted messages per time unit, fault statistics, for example, the number of faulty messages that occurred in a given time unit and the volume of the throughput data.

Accordingly to a variation of an illustrative, non-limiting formulation of the present invention, in a switch, several of these recording mechanisms may exist. They cannot be configured, however, to record only selected, required data. Instead, the entire data traffic flowing through the respective user or switch is recorded, such that the required data must be manually filtered out from the respective log lists of the respective switch or user. Particularly for real-time communication, however, the individual recording of events regarding single messages, that is, specific individual transactions, are important. Such a recording must be provided with a respective time stamp to make it possible to track or reconstruct the desired events. This makes it possible to draw conclusions regarding the optimization of the data traffic in the communication system, particularly for a real-time communication.

According to yet another variation of the exemplary formulation of the present invention, the diagnostic unit of the users assigns a unique identifier to the diagnostic and/or evaluated and/or recorded data concerning the communication relation between at least two users. For a cyclical operation of the communication system, this unique identifier has two or more parts. One part is provided for designating the cycle identifier and the other part for identifying the communication relation between the respective users. The cycle identifier may be the number of the current communication cycle, while the communication relation may be identified by a so-called frame ID of a data message. Alternative unique identifications are possible. Selected data recordings can thus be identified and uniquely assigned to specific users, particularly, to specific communication relations or communication connections between two or more users.

According to yet another variation of the illustrative variation of the present invention, the diagnostic unit of the users may be provided for the diagnosis and/or evaluation and/or recording of different events that occur in the data exchange between at least two users, particularly, for the diagnosis and/or the evaluation and/or the recording of fault events. Also, the diagnostic unit of the users may select the type and the number of the events to be diagnosed and/or evaluated and/or recorded, particularly fault events, and the associated data volume. In addition, the diagnostic unit may be provided for the port-specific and/or communication-specific diagnosis and/or evaluation and/or recording of the data traffic through a user.

The diagnostic unit of a user may be configured, for example, such that a selection of events or individual events concerning one or more communication connections between two or more users can be individually recorded. In particular, events concerning transactions of specific individual messages are diagnosed, evaluated, and recorded. For example, the arrival time of specific individual messages may be detected and recorded, while other events are ignored. The recorded events are, for example, the “time of arrival of data packet X,” “faults in data packet Y,” etc. Furthermore, the number of the events itself may be configured, such that, for example, a message is output after a certain number of one or more diagnostic events. This applies analogously to the associated data volume. It is also feasible to diagnose, evaluate, and/or record any other events, including, in particular, the entire data traffic in a user within a given time unit, or the data traffic of a selected port of a user.

For the analysis of fault situations or the tracing of faults that occurred, it is particularly advantageous that the diagnostic units can be configured such that selected fault events are diagnosed, evaluated, and recorded. For diagnosing, evaluating, and recording selected fault events, a number of different communication connections or relations among a number of users as well as specific communication relations or individual messages may be considered. Fault events are, for example, the arrival of messages at the wrong time, the number of messages received with the wrong content or the incorrect receipt of specific individual messages such as the failure to receive message X. This may be particularly useful for real-time critical data or in communications systems with real-time applications, since with fault events of this type, for example, the failure to receive messages or to receive them on time, the real-time capability is no longer guaranteed. The diagnosis, evaluation, and storage of fault events may also be port-specific and communication-specific.

This specific diagnosis of, for example, selected communication relations makes it possible to substantially reduce the information or data to be recorded. As a result, the evaluation of the data may also be simplified. In addition, the selection of the data to be diagnosed and/or recorded can be quickly and easily adapted to possible changes in the boundary conditions by a respective configuration of the diagnostic units involved. For example, based on a fault situation that occurred, it is possible, in addition to the events that are already being recorded, to separately record events correlated with a specific, desired message. Likewise, the data volume to be recorded can be reduced if the recording of certain events no longer appears to be necessary.

Preferably, at least one additional user is provided. This additional user is configured as a central diagnostic terminal. The central diagnostic terminal has a selection module to select the data to be diagnosed and/or evaluated and/or recorded and a configuration module to configure the respective diagnostic units of the other users.

In a communication system according to the illustrative, non-limiting formulation of the present invention, at least one diagnostic unit is integrated into each network node, which has a module diagnosing and/or evaluating and/or recording data concerning individual communication relations or connections between at least two users. Since the users in a communication system can communicate with each other, this central diagnostic terminal may be able to communicate with all the users, and thus with all the diagnostic units. Accordingly, this central diagnostic terminal may also transmit respective information and/or instructions to the diagnostic units of the respective users.

Particularly, in a communication system that is used for real-time applications, where the mutual communication traffic of all the users within the communication system is planned in advance to satisfy the real-time conditions, the identification of the data and all the network nodes through which the data pass is known. When such real-time data traffic is planned in advance, a so-called configuration tool is typically used in automation technology, which is particularly also a part of, or encompasses the central diagnostic terminal. The events to be recorded or diagnosed, particularly fault events, can then be selected, for example, by manual identification by a user or by automatic identification by the configuration tool and thus the central diagnostic terminal. Based on the relevant events thus selected, the central diagnostic terminal determines or knows the identification of the data and all the nodes through which these data pass. The central diagnostic terminal uses this information to generate the respective configuration information and sends this configuration information to all the users or network nodes involved, which in turn configure the integrated diagnostic units of the network nodes or the communication users to obtain the data to be diagnosed and recorded.

It is also conceivable that the configuration tool is not integrated in the user that is embodied as the central diagnostic terminal. When the configuration tool is not integrated into the central diagnostic terminal, the respective configuration information must be transmitted by the configuration tool to the central diagnostic terminal. This can be done, in particular, by exchanging data by using an infrared interface or a radio link, although a data transfer using diskettes is likewise possible. Other conventional transfers are also possible.

Another alternative to configure the individual diagnostic units of the users is for the central diagnostic terminal to use broadcast mechanisms to inform all nodes of the network as to which communication links or messages are to be monitored, for example. Each network node then uses its current configuration to determine whether it is the sender, the receiver, or the forwarder of the messages involved and adjusts its diagnostic units accordingly.

The central diagnostic terminal may eliminate the need to distribute a plurality of analyzers within the network. This may save both cost and time. Furthermore, the topology of a network no longer needs to be adapted, which is otherwise necessary whenever an additional analyzer must be inserted into a path. In addition, the respective diagnostic information is always available regardless of the central diagnostic terminal, so that a fault can be analyzed later. If the configuration through broadcast mechanisms is selected, the path of a message through a network does not need to be known, since the respective network nodes themselves check the diagnostic data to be monitored and optionally recorded. This specific diagnosis of communication relations makes it possible to reduce the volume of the information to be recorded. This may simplify the evaluation of the data. Furthermore, the resources required by the network nodes may be reduced.

This central diagnostic terminal may also be mobile; that is, the central diagnostic terminal can be connected to and can therefore dial into the communication network at any point, and does not necessarily need to be connected permanently to the communication system. This type of the central diagnostic terminal also ensures easy and flexible remote access to the respective diagnostic information at any time. Notebook embodiments are also conceivable and feasible. Dialing-in through a suitable radio link is also possible.

According to yet another illustrative variation of the exemplary formulation of the present invention, the central diagnostic terminal retrieves and/or evaluates the data recorded by the respective diagnostic units of the other users of the communication system. The diagnostic data are monitored in the individual network nodes by the diagnostic units integrated into the respective users, are optionally buffered in a so-called intermediate buffer and subsequently transferred to another memory of the user. From there, the central diagnostic terminal can retrieve and evaluate the diagnostic data online. In addition, the central diagnostic terminal, after retrieving the diagnostic data from the individual diagnostic units, can also be disconnected from the communication system. A respective evaluation of the retrieved information can be done off-line in the device itself. If new or different diagnostic information is required as a result of these evaluations, the diagnostic units of the individual network nodes can be directly reconfigured to immediately supply other diagnostic data.

The communication system may preferably be an automation system. However, it may also be used in automation systems, particularly packing machines, presses, plastic injection molding machines, textile machines, printing presses, machine tools, robots, handling systems, wood processing machines, glass processing machines, ceramics processing machines and lifting devices.

It may also be advantageous, if a user in a communication system is an automation device. Such a user may, in particular, be a network node with an integrated coupling unit. This integrated coupling unit may be a real-time Ethernet switch.

### BRIEF DESCRIPTION OF THE DRAWINGS

The present invention will now be described in detail by describing illustrative, non-limiting embodiments thereof with reference to the accompanying drawings. In the drawings, the same reference characters denote analogous elements, in which:

FIG. 1 is a block diagram of a communication system according to an illustrative, non-limiting embodiment of the present invention, and

FIG. 2 is an example of diagnostic data according to an illustrative, non-limiting embodiment of the present invention.

### DETAILED DESCRIPTION OF ILLUSTRATIVE, NON-LIMITING EMBODIMENTS

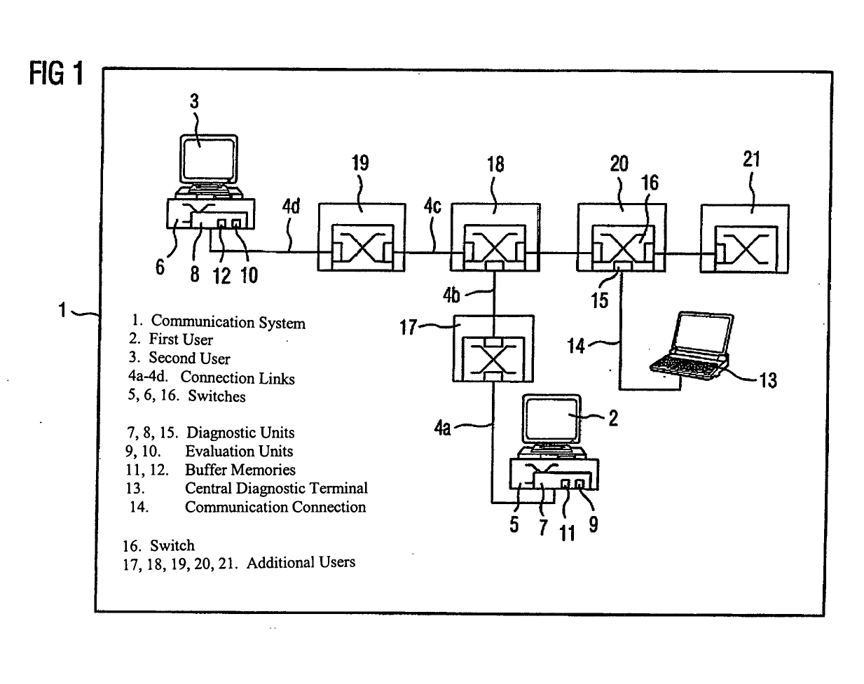

FIG. 1 shows a block diagram of a communication system 1 according to an exemplary, non-limiting embodiment of the present invention. The depicted communication system 1 represents, for example, a distributed real-time capable automation system. Moreover, this communication system 1 is a switched communication network. For example, it is a real-time Ethernet system. The communication system 1 depicted in FIG. 1 is a cyclically operating system. That is, in this communication system 1, the data are transmitted in one or more transmission cycles.

The depicted communication system 1 has a plurality of users, which can be simultaneously configured as senders and receivers. Specifically, the communication system 1 has a first user 2, a second user 3, and additional users 17, 18, 19, 20, 21. These users may be configured, for example, as computers and/or automation devices, such as drives.

Each user of the communication system 1 has an associated coupling unit, which is hereinafter also referred to as a switch. The coupling units are used to send and/or receive and/or forward the data to be transmitted. The coupling units or switches are preferably configured as real-time Ethernet switches. For reasons of clarity, only the switches 5, 6 of the first and the second user and the switch 16 of the user 20 are identified in FIG. 1. In all users, the associated switch may, for example, be integrated into the respective user.

One additional user may be configured as a central diagnostic terminal 13. The central diagnostic terminal 13 can, for example, also be integrated into a control computer of an automation system. The users are interconnected by communication links. For the sake of clarity, only the connection between the users 2 and 3 is identified and depicted in FIG. 1 by the communication links 4a, 4b, 4c and 4d. As mentioned above, the users are also sometimes referred to as network nodes.

Each switch has several ports, which are not depicted or identified for reasons of clarity. The communication links ending in or at a switch symbolize the different ports. According to illustrative embodiment of the present invention, each of the switches has at least one diagnostic unit. For the sake of clarity, only the diagnostic unit 7 of the first user 2, the diagnostic unit 8 of the second user 3 and the diagnostic unit 15 of the user 20 are identified in FIG. 1. These diagnostic units 7, 8, and 15 are provided for the diagnosis of data concerning the data exchange between the network users, for example, between the first user 2 and the second user 3.

The diagnostic units 7, 8, 15, and the central diagnostic terminal 13 can be configured so that only a specified selection of events are diagnosed. Particularly, these diagnostic units 7, 8, 15 and the central diagnostic terminal 13 can be configured to diagnose fault events concerning the communication connections between the users. By way of an example, these diagnostic units 7, 8, 15 and the central diagnostic terminal 13 can individually diagnose, evaluate, and record single message transactions, while ignoring all other events.

The events to be selected are, for example, the “time of arrival of data packet X in the user 2,” “wrong time of arrival of message Y in the user 3,” etc. The diagnosis, evaluation and/or recording of any other events is also possible. For example, the whole data traffic of user 3 within a given time unit may be recorded. This specific diagnosis of communication relations makes it possible to reduce the volume of the information to be information to be recorded. This substantially simplifies the evaluation of the data. The resources required by the network nodes are also substantially reduced.

For some of the network users, several diagnostic units per user are possible. These diagnostic units, which are integrated into the respective network users or switches, diagnose, evaluate, or record port-specific data. In the example depicted in FIG. 1, a diagnostic unit is shown for each incoming or outgoing communication link, i.e., diagnostic unit 7 of user 2, diagnostic unit 8 of user 3, and the diagnostic unit 15 of user 20. The respective diagnostic unit is preferably configured such that only a single diagnostic unit is integrated into the respective user or switch, so that each port of the respective switch or network user can be diagnosed separately. If required, however, the respective network users can also be equipped with several diagnostic units each.

Each diagnostic unit has at least one evaluation unit and at least one buffer memory. This evaluation unit is provided for evaluating the diagnostic data. For the sake of clarity, only the evaluation units 9 and 10 and the buffer memories 11 and 12 of the diagnostic units 7 and 8 of the users 2 and 3 are shown in FIG. 1. The evaluation units and buffer memories of the other diagnostic units are not shown or identified.

The buffer memories 11, 12 are provided for buffering the diagnostic data. For example, the buffered data may be the data sent by the first user 2 to the second user 3 or vice versa. Prior to buffering, the diagnostic data is optionally evaluated by the evaluation units 9, 10. The buffered data are subsequently transferred into a memory of the respective users from where they can be retrieved and centrally evaluated at any, particularly also at a later time, for example, by the central diagnostic terminal 13. The diagnostic information is thus permanently available in the memories of the users. Consequently, a fault analysis may be performed even at a later time.

The central diagnostic terminal 13 is connected, for example, via the communication connection 14, with the switch 16, which is integrated into the user 20. More precisely, the central diagnostic terminal 13 is connected with the diagnostic unit 15 integrated into the switch 16 of the user 20 via the communication connection 14. Consequently, the terminal 13 is a user of the communication network 1. As a network user, the central diagnostic terminal 13 has access to all the other users. It is furthermore designed to configure the diagnostic units of the other users, to retrieve and separately evaluate the data of the diagnostic units of the other users, which were buffered, for example, in the buffer memories or the other memories of the users themselves and were optionally evaluated. This accessibility into the diagnostic data of the other users makes it possible for the central diagnostic terminal 13 to perform a central diagnosis of the communication system 1. The diagnostic data retrieved in this manner can be evaluated online within the central diagnostic terminal 13. However, after retrieving the diagnostic data from the individual diagnostic units, the central diagnostic terminal 13 can also be disconnected from the communication system 1, and the data can be evaluated offline. If, as a result of this evaluation, new or different diagnostic information is required, the diagnostic units of the individual network nodes can be directly reconfigured to supply other diagnostic data.

Particularly, in a distributed real-time critical automation system such as the one depicted in FIG. 1, communication among all the users is planned in advance to satisfy the real-time conditions. The identifiers of the data and all the network nodes or users through which the data pass are therefore known. To plan such real-time data traffic in advance, a so-called configuration tool is normally used in automation technology and is preferably part of the central diagnostic terminal 13. The events to be recorded or diagnosed, particularly the fault events, can be selected manually by a user or automatically by the configuration tool and thus by the central diagnostic terminal 13 itself. The central diagnostic terminal 13 uses the relevant events thus selected to generate the respective configuration information and transmits this information to all the users or network nodes involved, for example, users 2 and 3, which in turn configure the integrated diagnostic units 5 and 6 to obtain the desired diagnostic data.

It is also conceivable that the configuration tool is not integrated in the central diagnostic terminal 13. If the configuration tool is not integrated into the central diagnostic terminal 13, the respective configuration information must be transmitted from the configuration tool to the central diagnostic terminal 13. To transmit the configuration information from the configuration tool to the central diagnostic terminal 13 is feasible, for example, by exchanging the data over an infrared interface or a radio link or by transferring the data through diskettes. Other conventional transfer methods are also possible and are within the scope of this invention.

Another alternative for configuring the individual diagnostic units of the users is the use of broadcast mechanisms by the central diagnostic terminal to contact all the nodes of the network. For example, broadcasting mechanisms may be used to request the monitoring of the communication between the users 2 and 3. Each network node then uses its current configuration to determine whether it is a sender, receiver or forwarder of the messages involved and adjusts its diagnostic units accordingly. In the example depicted in FIG. 1, the users 17, 18, and 19 would be affected as forwarders and the users 2, 3 as both senders and receivers. The other users 20, 21 would not be affected.

The central diagnostic terminal 13 may also be configured as a mobile terminal, for example, a notebook. If the central diagnostic terminal 13 is a mobile terminal, then the central diagnostic terminal 13 can be connected to any user of the communication network 1 at any time, or can dial into the communication network 1, and thus, does not necessarily need to be permanently connected to the communication system 1. This also provides a simple, flexible, and central way for remote access to the respective diagnostic information of the individual network users, particularly, at some later point in time. Dialing-in via a suitable radio link is also possible and is within the scope of this invention.

The implementation of a central diagnostic terminal 13 as described above eliminates the need for distributing a plurality of analyzers within the network, which saves both cost and time. Furthermore, there is no need to change the topology of a network, which is otherwise required whenever an additional analyzer must be inserted into a path. If the configuration via broadcast mechanisms is selected, the path of a message through a network need not be known since the respective network nodes themselves check the diagnostic data to be monitored and optionally recorded.

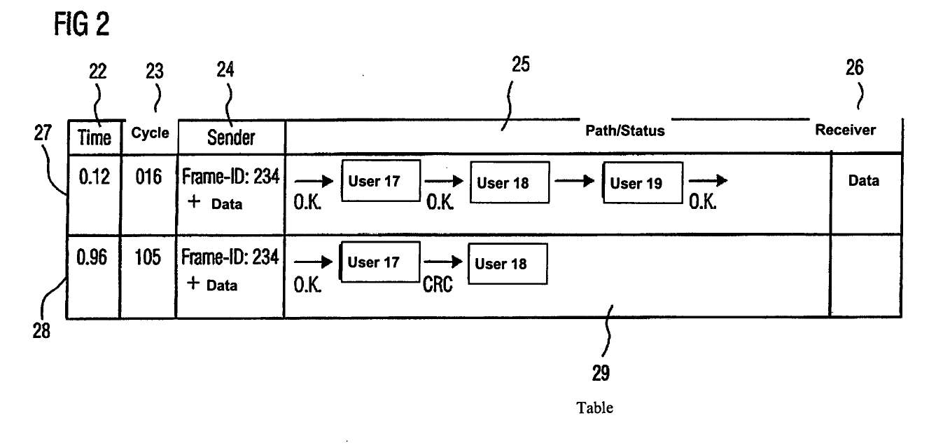

FIG. 2 shows an exemplary display of diagnostic data in the central diagnostic terminal 13 in the form of a table 29. In the example shown in FIG. 2, the data traffic between the users 2 and 3 depicted in FIG. 1 is to be monitored for the occurrence of events of any type, during the time interval 0.00 to 1.00 of a given time unit.

The first column 22 of the table 29 lists the instants when an event occurred in the relevant time interval. To be able to uniquely assign the recorded events to a specific communication relation between, for example, two users, the diagnostic units of the users assign the diagnostic or recorded events a unique identifier. In a cyclical operation of the exemplary communication system 1 depicted in FIG. 1, the unique identifier has, by way of an example, two parts. One part identifies the communication cycle and the other part the communication relation between the users involved, for example, users 2 and 3, i.e., the sender and the receiver. Thus, the second column 23 of the table 29 lists for each recorded event the communication cycle during which the respective event occurred. The third column 24, using a so-called frame ID, uniquely identifies the sender of the respective data packet and the associated receiver. In the example depicted in FIG. 2, the frame ID “234” uniquely identifies the user 2 as the sender and the user 3 as the receiver of the transmitted data. The fourth column 25 of the table 29 lists the path of the data packet to the receiver via all the intermediate stations, including the respective status of the transmitted data packet. The fifth column 26 documents the arrival of the data packet at the receiver.

In the example depicted in FIG. 2, two events occurred during the relevant time interval, which concern the communication relation between the user 2 as the sender and the user 3 as the receiver. The first event is listed in the first line 27 of the table 29 and shows that a data packet was correctly transmitted in the communication cycle “016” by the user 2 via the users 17, 18 and 19 to the user 3, and this data packet was received by the user 3 at the instant “0.12.” The second event depicted in FIG. 2, given by way of example, is listed in the second line 28 of the table 29. The second line 28 of table 29 shows that the user 2 correctly forwarded a data packet to the user 17 in the communication cycle “105.” As the data packet was forwarded to the user 18, however, a fault in the line occurred (CRC—cyclical redundancy check), such that the data packet was not, or not correctly received by the user 18. As a result, this data packet failed to reach the correct receiver, user 3.

Using such a specific diagnosis of selected communication relations makes it possible to significantly reduce the amount of the information or data to be recorded. As a result, the evaluation of the data is simplified. In addition, the selection of the data to be diagnosed and/or recorded can be adapted very quickly and easily to any changes in the boundary conditions by a respective configuration of the affected diagnostic units. For example, based on a fault situation, it is quickly and easily possible to separately record, in addition to the events that are already to be recorded, events that correlate with a specific desired message. Likewise, the data volume to be recorded can be reduced, if the recording of certain events no longer appears to be necessary.

According to the illustrative embodiment of the present invention, a distributed automation communication system 1, particularly a real-time critical, cyclic, real-time Ethernet system, has a number of users. Each user of this system has at least one diagnostic unit 7, 8, 15 for diagnosing and recording data concerning the data exchange between users. Also, in this communication system 1, an additional user configured as a central diagnostic terminal 13 is provided. The central diagnostic terminal 13 performs a central diagnosis of the entire communication system 1 by configuring the diagnostic units 7, 8, 15 of the users and by retrieving and evaluating the diagnostic data recorded by the diagnostic units 7, 8, 15 of the users.

The above description of illustrative, non-limiting embodiments and variations thereof has been given by way of an example. The above and other features of the invention including various novel method steps and components have been particularly described with reference to the accompanying drawings and pointed out in the claims. It will be understood that the particular process and construction of parts embodying the invention is shown by way of an illustration only and not as a limitation of the invention. The principles and features of this invention may be employed in varied and numerous embodiments without departing from the scope of the invention as defined by the appended claims and equivalents thereof.

1. A communication system comprising:
at least one first user;
one second user; and
at least one communication connection interconnecting said second user and the first user,
wherein the first user and the second user each has at least one diagnostic unit, providing diagnosis of data concerning data exchange of at least one communication relation between at least two users from the first user and the second user.

2. The communication system as claimed in claim 1, wherein each of the diagnostic units has at least one evaluation unit evaluating the diagnostic data.

3. The communication system as claimed in claim 1, wherein each of the diagnostic units has at least one buffer memory buffering the diagnostic data.

4. The communication system as claimed in claim 1, wherein the communication system is one of a switched Ethernet type communication system and a real-time Ethernet type communication system.

5. The communication system as claimed in claim 1, wherein the communication system is a cyclically operating communication system.

6. The communication system as claimed in claim 1, wherein the diagnostic unit assigns a unique identifier to at least one of diagnostic, evaluated, and recorded data concerning a communication relation between the at least two users.

7. The communication system as claimed claim 1, wherein, for a cyclical operation of the communication system, a unique identifier assigned to the diagnosis of the data comprises two parts, and wherein a first part designates a cycle identifier and a second part identifies the communication relation between the at least two users.

8. The communication system as claimed in claim 1, wherein the diagnostic unit is provided for at least one of the diagnosis, evaluation, and recording of different events that occur in the data exchange between the at least two users.

9. The communication system as claimed in claim 8, wherein the diagnostic unit selects a type and a number for at least one of diagnosed, evaluated, and recorded events, as well as a volume of associated data.

10. The communication system as claimed in claim 8, wherein the diagnostic unit is provided for at least one of the diagnosis, evaluation, and recording of fault events that occur in the data exchange between the at least two users.

11. The communication system as claimed in claim 1, wherein the diagnostic unit is provided for at least one of port-specific and communication-specific diagnosis, evaluation, and recording of the data exchange between the at least two users.

12. The communication system as claimed in claim 1, further comprising:
at least one additional user is provided; the at least one additional user being configured as a central diagnostic terminal,
wherein the central diagnostic terminal has a selection module selecting the data for at least one of diagnosis, evaluation, and recordation, and a configuration module respectively configuring respective diagnostic units of remaining users.

13. The communication system as claimed in claim 12, wherein the central diagnostic terminal is provided to perform at least one of retrieval and evaluation of the data recorded by the respective diagnostic units of the remaining users of the communication system.

14. The communication system as claimed in claim 1, wherein the communication system is configured in an automation system.

15. A user in a communication system comprising:
a diagnostic unit,
wherein the diagnostic unit is provided for diagnosing data concerning data exchange of at least one communication relation between at least two users.

16. The user as claimed in claim 15, wherein the diagnostic unit of the user has at least one evaluation unit evaluating the diagnostic data.

17. The user as claimed in claim 15, wherein the diagnostic unit has at least one buffer memory buffering the diagnostic data.

18. The user as claimed in claim 15, wherein the diagnostic unit assigns a unique identifier to at least one of the diagnostic data, evaluated data, and recorded data, concerning the communication relation between the at least two users.

19. The user as claimed in claim 15, wherein the diagnostic unit is provided for at least one of the diagnosis, evaluation, and recording of different events that occur in the data exchange between the at least two users.

20. The user as claimed in claim 19, wherein the diagnostic unit selects a type and a number of the events that are to be at least one of diagnosed, evaluated, and recorded, as well as a volume of associated data.

21. The user as claimed in claim 19, wherein the diagnostic unit is provided for at least one of the diagnosis, evaluation, and recording of fault events that occur in the data exchange between the at least two users.

22. The user as claimed in claim 15, wherein the diagnostic unit is provided for at least one of port-specific and communication-specific diagnosis, evaluation, and recording of data traffic through a user.

23. The user as claimed in claim 15, wherein the user is configured as a central diagnostic terminal, and wherein the central diagnostic terminal comprises a selection module selecting the data for at least one of diagnosis, evaluation, and recordation, and a configuration module configuring respective diagnostic units of remaining users.

24. The user as claimed in claim 23, wherein the user configured as the central diagnostic terminal further comprises a retrieval module performing at least one of retrieving and evaluating the data recorded by the respective diagnostic units of the remaining users.

25. The user as claimed in claim 15, wherein the user is a network node with at least one of an integrated coupling unit and an automation device.

26. The user as claimed in claim 25, wherein the integrated coupling unit is a real-time Ethernet switch.
